(19) United States
(12) Patent Application Publication
(10) Pub. No.: US 2002/0124463 A1
(43) Pub. Date: Sep. 12, 2002

(54) Landscape fabric with hydration dams

(75) Inventor: Michael L. Venable, Scottsboro, AL (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Kappler Safety Group, Guntersville, AL

(21) Appl. No.: 10/034,357

(22) Filed: Dec. 28, 2001

Related U.S. Application Data
(60) Provisional application No. 60/258,378, filed on Dec. 28, 2000.

(51) Int. Cl. A01G 7/00

(52) U.S. Cl. 47/9

(57) ABSTRACT

A landscape fabric is disclosed that maximizes the use of natural and irrigated water. The landscape fabric includes at least one layer of fluid pervious material, and a plurality of hydration dams attached to the surface of the pervious material. The hydration dams capture irrigation and natural water run-off, which provides more efficient moisture control to the underlying surface and landscape plantings.

### FIELD OF THE INVENTION

The present invention relates to agriculture and horticulture, and more specifically to a landscape fabric for improving plant hydration through moisture management.

### BACKGROUND OF THE INVENTION

Landscape control fabrics are known in the art. In particular, landscape fabrics, or “agrotextiles,” are typically at least partially pervious to air and water, and include a variety of woven and nonwoven materials, such as spunbonded polypropylene, melt blown-spunbonded-meltblown polyethylene (SMS), Typar®, needle punched polyolefin, cross-laminated films, as well as both perforated and non-perforated films. Agrotextiles are used extensively in both commercial and consumer applications with the primary purpose of preventing the growth of undesirable vegetation, such as weeds. Advantageously, agrotextiles have proven effective at suppressing weed growth by eliminating the light necessary to support germination and growth of seedlings buried below the soil surface. In this regard, the ideal agrotextile exhibits low light transmission, but a high degree of water and air permeability. Some agrotextiles also include various growth enhancing and control additives.

While conventional agrotextiles have addressed the need for low light transmission and both high moisture and air permeability, conventional agrotextiles have not addressed the need of maximizing moisture control. More specifically, a major challenge during construction and landscaping design is the control of natural and irrigated water. It is common practice to channel the flow of water away from and around structural foundations to avoid the deleterious effects of long term and repeated contact with drainage water. The most common and time-proven approach to controlling drainage water is to slope or grade the land away from the foundation to channel the drainage water to a lower elevation. Further control measures can also be taken using subterranean techniques, such as French drains that incorporate a buried perforated pipe lying on a bed of crushed rock.

One of the benefits of traditional surface drainage control is the use of sloped areas for ornamental plantings. Commonly called “raised beds,” these sloped areas are considered ideal by landscape designers for the aesthetic characteristics. Since good drainage is critical in the field of horticulture and agriculture, these sloped beds prevent water build-up and standing water, which can lead to root mold and rot if left unattended. The practice of raising and sloping planting beds is common practice in home and commercial horticulture.

Assuming that the requirements for ideal soil composition exist, moisture management remains as a key element to successful horticulture. Most ornamental planting beds, which often include a variety of annual, perennial, deciduous, and non-deciduous plant species, typically receive both natural and irrigation water to maintain adequate plant and soil hydration. Optimal hydration can be a challenge in arid regions, areas of poor soil composition, and during times of drought. These situations can lead to excessive and expensive supplemental irrigation. In addition to hydration control, it is also desired for ornamental and commercial plantings to be low maintenance, i.e., free from weeds and other undesirable vegetation.

Previous attempts have been made to control hydration and minimize or eliminate growth of undesirable vegetation in commercial and home planting beds. One of the earliest and still practiced approaches is the use of mulch. Most often in the form of wood chips, bark, pine straw, and other similar natural products, mulch has proven effective at aiding to control hydration and weed growth. Mulch, however, has several disadvantages, such as the expense and time required to disperse it, particularly over a large planting area. Another disadvantage to mulch is its spatial instability, especially during times of heavy precipitation. A further disadvantage of mulch is its relatively high absorption rate, whereby a significant amount of the natural and irrigated water falling on the mulch is actually absorbed instead of delivered to the underlying plant root system.

As described above, landscaping fabrics are another approach to control undesirable vegetation. These fabrics typically take the form of a “mat” that is placed over the planting soil thereby eliminating light transmission to the soil. Examples of landscaping fabrics are described in U.S. Pat. Nos. 5,048,228; 5,058,317; 6,029,395; 6,161,776; 6,233,867; and 6,293,045. These patents are primarily concerned with preventing unwanted vegetation growth, and merely assume that a high level of moisture permeability will provide effective and efficient moisture control. These patents fail to recognize that a majority of conventional landscape fabrics are synthetic in nature and actually shed water, particularly when used in sloped planting beds. For example, many conventional landscape fabrics are formed from polyolefin fibers, which are hydrophobic and therefore shed substantially a majority of incident water instead of absorbing and evenly transferring it to the underlying soil.

Thus, there exists a need for a landscaping fabric that prevents the growth of undesirable vegetation, and that exhibits improved moisture control capabilities. In particular, there exists a need for a landscaping fabric that offers a high degree of air and water permeability, but also functions in a way to maximize moisture management by preventing run-off of irrigated and natural water.

### BRIEF SUMMARY OF THE INVENTION

These and other needs are provided by the landscaping fabric of the present invention, which comprises a material that is pervious to fluids, such as air and water, yet provides enhanced moisture control through the use of a plurality of water impervious hydration dams that prevent run-off of irrigated and natural water by holding the water on the surface of the pervious material and thus giving the material time to absorb and transport the water through the material and into the underlying soil.

In particular, the landscaping fabric according to one embodiment of the present invention comprises at least one layer of a fluid pervious material, such as a synthetic polymer material, having a first and second surface. The material can be woven, nonwoven, or a combination thereof. The material may also be biodegradable. The material has an absorption capacity ratio of at least about 1.0, and preferably has an absorption capacity ratio of at least about 4.5. According to one embodiment, the fluid pervious material defines at least one opening for extending a landscape planting, such as a tree, therethrough.

At least one hydration dam, which may take the form of at least one water impervious rib, is carried by and projects from the first surface of the material to capture or hold run-off from natural or irrigated water. Preferably, a plurality of hydration dams project from the first surface of the material and are arranged in a predetermined pattern, such as a concentric arrangement, rows, or other geometric shape to capture water run-off. According to one embodiment, the hydration dams are formed from a thermoplastic material, and can be either self-adhered directly to the first surface of the material, or adhered to the material using an adhesive. The hydration dams are also capable of holding fertilizer, mulch, and other objects in place for a longer period of time compared to conventional landscaping fabrics.

In another embodiment, the landscape fabric comprises at least one hydration dam projecting from a first fluid pervious layer, and a second fluid pervious layer proximate the first layer, such as being in opposite facing relation thereto. The fabric also includes a plurality of bonds bonded together the first and second layers to form a composite nonwoven fabric. The first layer has a basis weight of about 0.5 to about 5 ounces per square yard, and the second layer has a basis weight of about 0.5 to about 5 ounces per square yard. Advantageously, an additive layer is interposed between the first and second layers. The additive layer preferably includes a material that benefits a landscape planting, such as fertilizers, fungicides, insecticides, nutritional supplements, pre-emergent herbicides, and post-emergent herbicides.

The landscape fabric can have many configurations, and in one embodiment can be in the form of a roll of a predetermined width that can be unrolled when applied to the landscape surface. In this regard, the landscape fabric also includes a plurality of perforations in the fluid pervious layer(s) for sizing the landscape fabric to a predetermined size and shape. For example, in one embodiment the landscape fabric is in the form of a roll of a predetermined width, and a plurality of hydration dams extend longitudinally transverse to the width dimension of the roll. A plurality of perforations extend into the pervious material along the longitudinal axis of the fabric whereby the fabric can be removed along the perforations such that the resulting fabric has a predetermined width less than the initial width. This embodiment is particularly advantageous when planting multiple objects in rows, as the landscape fabric can be sized to meet the needs of the particular planting operation. Advantageously, at least one hydration dam is positioned between the plurality of perforations for collecting run-off water and providing more controlled moisture release to the underlying soil.

The perforations can also be arranged in other formations, such as concentric circles or other geometrically configured arrangements. For example, in one embodiment a plurality of ribs are arranged in a pattern of concentric circles, and a plurality of perforations are also arranged in a concentric circle arrangement and positioned between adjacent ribs at predetermined intervals, whereby portions of the fabric can be removed along the perforations to reduce the surface area and diameter thereof. In this regard, the landscape fabric can be placed around a tree and sized accordingly by removing unwanted material at the perforations. Run-off water is thereafter captured by the concentric ribs and transported through the pervious material to the underlying surface.

Accordingly, the landscape fabric of the present invention provides an improved moisture delivery system to home and commercial landscaping by providing a plurality of hydration dams for capturing run-off irrigation and natural water and holding the water so the pervious material can absorb more liquid and thus transfer more liquid and nutrients to the underlying surface and root system of the landscape planting.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 is a perspective view of a landscape fabric shown around a tree according to one embodiment of the present invention;

FIG. 2 is a plan view of a landscape fabric according to one embodiment of the present invention;

FIG. 3 is a cross-sectional view of the landscape fabric shown as seen along lines 3--3 of FIG. 2;

FIG. 4 is a cross-sectional view of a landscape fabric according to another embodiment of the present invention;

FIG. 5 is a plan view illustrating a landscape fabric according to one embodiment of the present invention;

FIG. 6 is a detailed plan view of the landscape fabric shown in FIG. 5; and

FIG. 7 is a perspective view of a landscape fabric in rolled form according to one embodiment of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

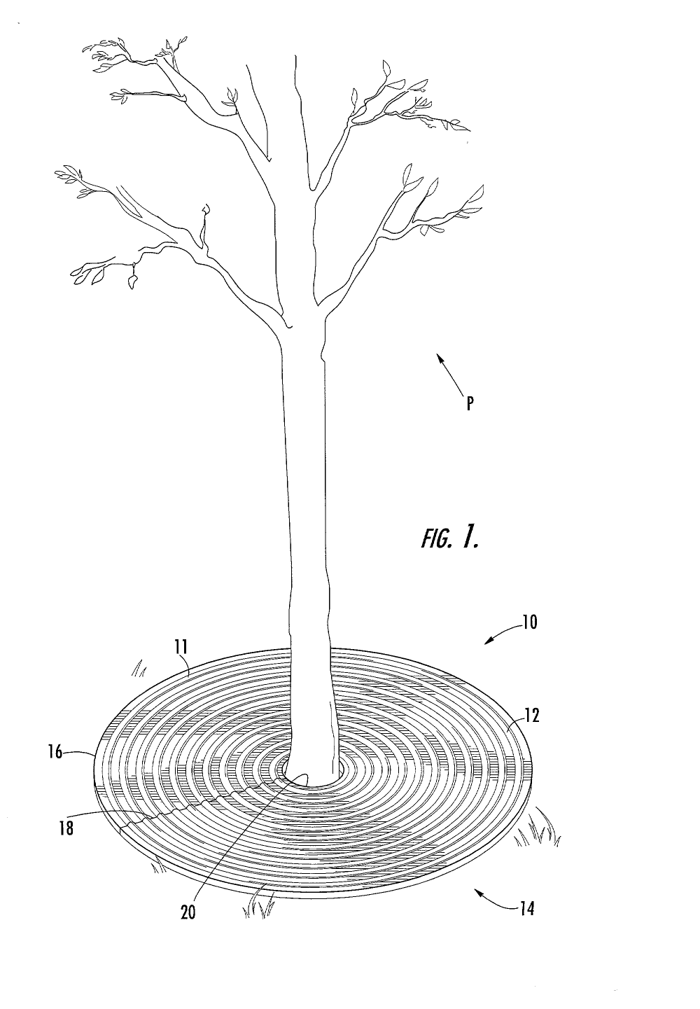

FIGS. 1-3 show one embodiment of a landscaping fabric according to one embodiment of the present invention. In particular, FIG. 1 shows a landscape fabric 10 in use around a landscape planting P, such as a tree. The fabric 10 comprises at least one layer of a fluid pervious sheet material 11 having an upper surface 12 and a lower surface 14. A slit 18 extends from an edge 16 of the fabric 10 to an opening 20 defined by the fabric for accommodating the planting P. The sheet material 11 is formed of synthetic polymer fibers, such as polyester, polyamide, or other synthetic fibers. The fibers may be formed with a woven fabric or scrim, or a nonwoven fabric in accordance with various known nonwoven manufacturing methods. Examples of suitable nonwoven fabric constructions include spunbonded nonwovens, spunbond-meltblown-spunbond (SMS) nonwovens, wetlaid nonwovens, and carded nonwovens. Examples of commercially available nonwovens include Duon ™, a product of BP, and Typar®, a polyolefin nonwoven produced by BBA Nonwovens. The sheet material 11 can also be formed of natural fibers, and can be biodegradable as well.

The sheet material 11 has an absorption capacity ratio of at least about 1.0, and preferably at least about 4.5. Absorption capacity ratio is defined herein as a multiple of the base fabric weight prior to water immersion. To measure the absorption capacity ratio of a swatch of material according to the present invention, the swatch is weighed dry, and then immersed in water for 3 minutes. The swatch is then removed and placed on a drain screen for about 3 minutes, and then weighed again. The absorption capacity ratio is the ratio of water contained in the material (wet weight—dry weight) divided by the dry weight. Generally, greater absorption capacities will ideally lead to a higher degree of water transmission through the material and thus to the underlying soil and root system. See Table 1 below.

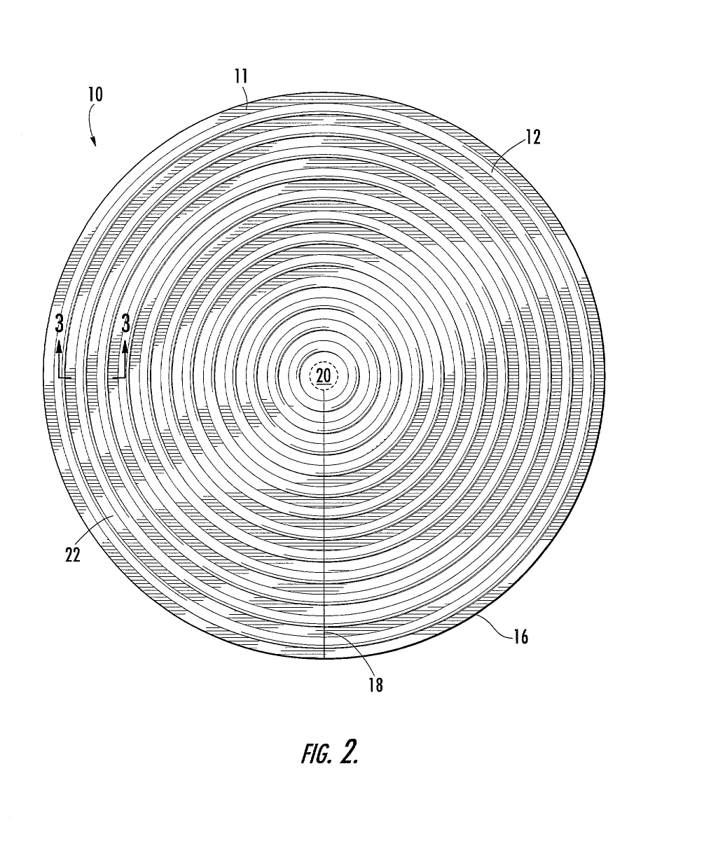

The fabric 10 may comprise a single layer of sheet material or may be a composite fabric comprising two or more layers of sheet material. The layers may be joined together using adhesives or by fusion bonds, such as thermal point bonds. The fabric 10 can have many sizes and shapes. For example, in FIGS. 1 and 2 the fabric 10 is shown as a generally circular disk, but the fabric can also be in roll form along a longitudinal axis (see FIG. 7). The fabric 10 can also be in other predetermined geometric shapes, such as polygonal, oval, etc., although irregular shapes are also within the scope of the present invention. In one embodiment, the fabric 10 is in the form of a generally circular disk having a diameter of about 48 inches, although the diameter can initially be more than or less than 48 inches, and preferably the diameter or size of the fabric can be selected by the consumer, as discussed more fully below.

Referring to FIG. 2, the fabric 10 is shown with a plurality of ribs or hydration dams 22 that are carried by and project from the first surface of the layer of material 11. While the present invention contemplates at least one hydration dam, a plurality of dams are preferable for assisting in directing water and other irrigation fluids to the underlying soil. As shown in FIG. 2, the dams 22 preferably are positioned substantially over the area defined by the upper surface 12 of the material 11. According to one embodiment, the dams 22 are formed from a water impermeable thermoplastic material, although other materials may also be used, such as rubber for example, which can be applied in molten form to the material 11 and which will self-adhere to the material upon cooling. Exemplary compositions include polyamides, polyesters, synthetic rubbers, or polyolefins. The composition may contain filler as well as conventional additives and UV stabilizers. The dams 22 can also be adhered to the upper surface 12 of the material 11 with an adhesive. The dams 22 are arranged to form a predetermined geometrical shape on the upper surface 12 of the material 11. Preferably, the shape of the dams 22 is similar to the shape of the fabric 10, such that a circular landscape fabric includes a plurality of dams arranged in concentric circles centered about the opening 20 defined in the center of the circular landscape fabric. Alternatively, other endless closed geometrical shapes could be used.

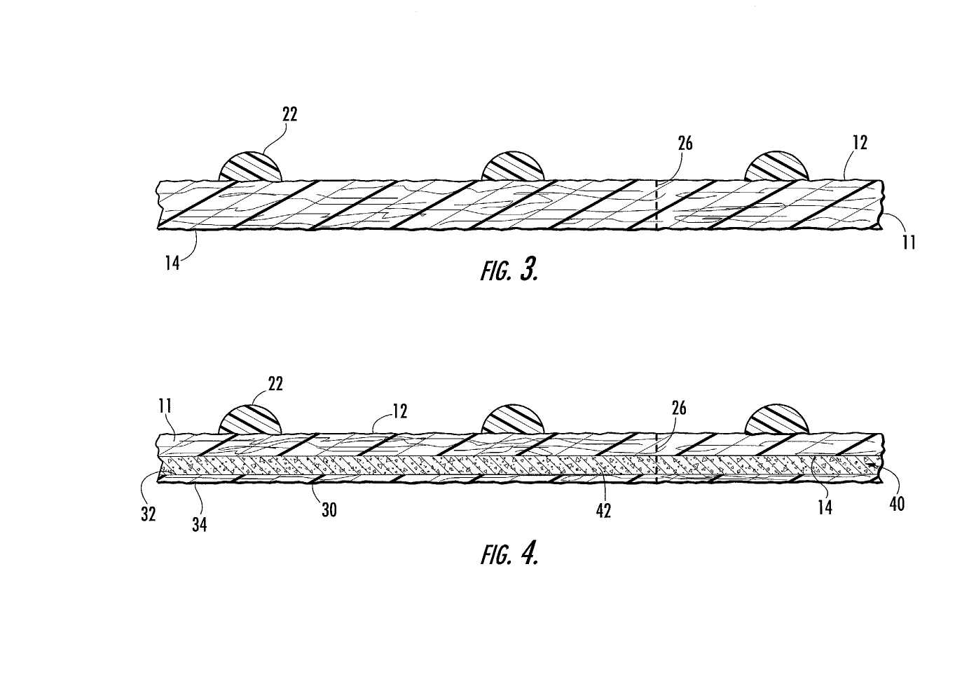

For illustrative purposes only, the landscape fabric 10 shown in FIGS. 2 and 3 can be formed such that the fabric has an outer diameter of about 48 inches. The dams 22 are spaced about ½ to about 1 inch apart, and have dimensions of about 1/16 to about ¼ inch wide and about ¼ to about ½ inch in height. The dams 22 can be of a variety of shapes, such as the rounded shape shown in FIG. 3, as well as rectangular or other shapes. According to the present invention, the dams 22 effectively hold water, such as natural water and irrigation water, on the upper surface 12 of the material 11 instead of allowing the water to run off the fabric 10. In addition, the dams 22 hold mulch, fertilizer, and other objects placed on the fabric 10, which thereby keeps the fabric out of sight for a longer period of time and provides an improved nutrient delivery system to the underlying soil and root system of the landscape planting.

FIG. 3 also shows another advantageous feature according to one embodiment of the present invention. More specifically, the landscape fabric 10 includes a plurality of perforations 26 that extend through the material 11 to facilitate separating and removing portions of the material. In this regard, the fabric 10 can be sized according to the particular landscape planting. Preferably, the perforations 26 form patterns similar to the patterns formed by the dams 22. For example, in the fabric 10 shown in FIGS. 2 and 3, the perforations 26 define a plurality of concentric circles that are similar to the concentric circles defined by the dams 22. The perforations 26 are preferably spaced at greater intervals compared to the dams 22, i.e., about every 4-6 inches versus about every ½-1 inch, although the perforations could be spaced at greater or lesser intervals. The perforations 26 can also be located under one of the dams 22. Advantageously, the perforations 26 provide a tear away seam to accommodate different sizes of landscape plantings. The perforations 26 can have other shapes as well, as discussed more fully below. It should also be noted that the center opening 20 and slit 18 described above may also be formed by separating perforations along predetermined locations.

FIG. 4 shows another embodiment of the present invention, wherein the fabric 10 includes a second layer of a fluid pervious material 30 positioned proximate the first layer 11, such as being in opposing facing relation to the lower surface 14 of the first layer 11 of material. A plurality of bonds are provided for bonding together the first and second fluid pervious layers to form a composite nonwoven fabric. In this regard, the second layer 30 has an upper surface 32 and a lower surface 34, and the second layer is adhered to the first layer 11 using an adhesive 42, such as a spray adhesive or the like that forms the plurality of bonds. The first layer 11 and second layer 30 could also be attached by a thin layer of raised edges (not shown) extending therebetween. Advantageously, an additive material 40, such a fertilizer, fungicide, insecticide, nutritional supplement, pre-emergent herbicide, post-emergent herbicide, or mixtures thereof, are disposed between the first layer 11 and the second layer 30. Thus, the additive material 40 is slowly dispensed during each watering instead of being rinsed away, particularly during heavy precipitation. As discussed above, the perforations 26 extend substantially through the fabric 10 to facilitate removal of a portion of the fabric and thus size the fabric according to the particular landscape planting.

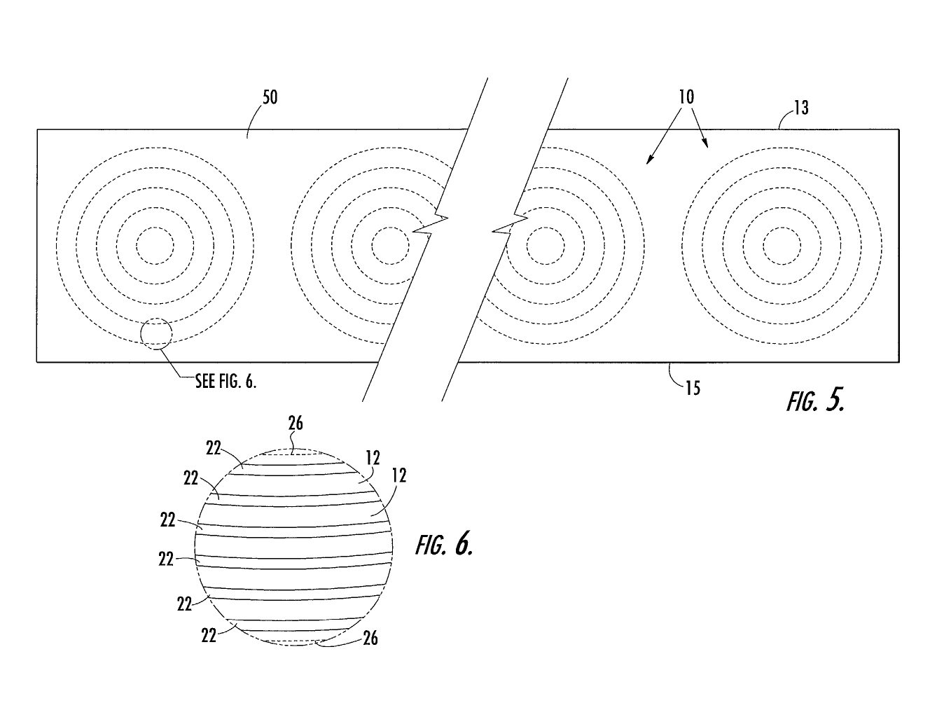

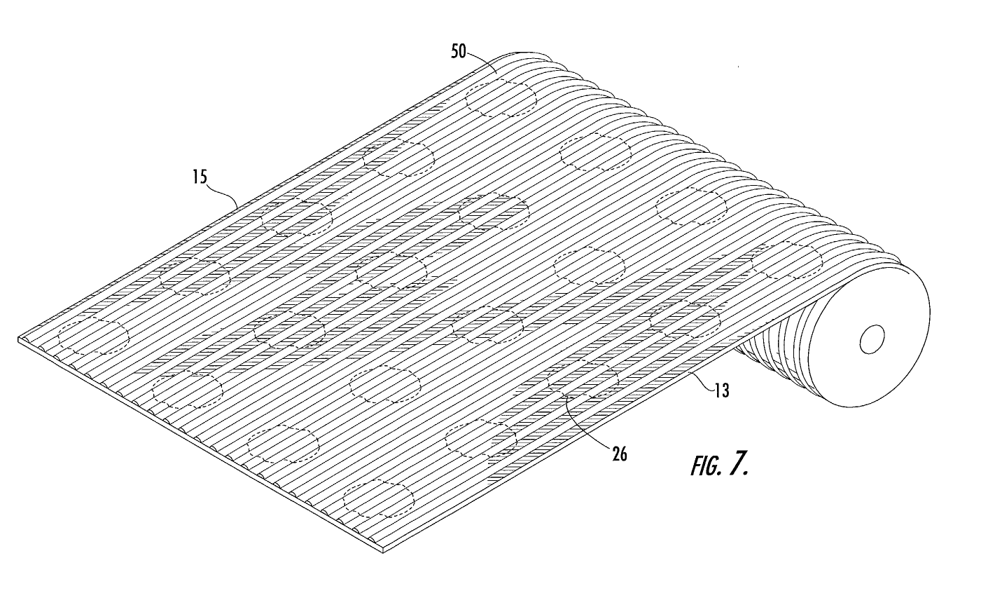

FIGS. 5 and 6 show plan views of a landscape fabric sheet 50 comprising a plurality of generally circular landscape fabric disks 10 extending substantially across the width of the fabric from one edge 13 to another 15. As shown in FIG. 6 and described above, each fabric 10 includes the fluid impervious layer 11, a plurality of water impervious hydration dams 22, and preferably a plurality of perforations 26 extending through the fabric. As shown in FIG. 5, the fabric sheet 50 is formed from the fluid pervious material described above, and the finished landscape fabric 10 is formed on the surface of the sheet.

FIG. 7 shows yet another embodiment of a landscape fabric according to the present invention. In particular, the landscape fabric sheet 50 according to this embodiment is in the form of a roll of a predetermined width, and wherein the hydration dams 22 extend longitudinally transverse to the edges 13, 15 of the fabric sheet. This embodiment is particularly advantageous when planting rows of plants or flowers in raised beds. In this regard, a plurality of perforations are provided through the fabric sheet 50 at predetermined and spaced intervals to facilitate separating the sheet for plantings to extend therethrough. It should also be noted that the fabric sheet 50 shown in FIGS. 5-7 may have multiple layers of fluid pervious material and may also include the additive layer 40 discussed above. In addition, the fabric sheet 50 may also include a plurality of perforations extending substantially parallel with the hydration dams 22 such that the width of the roll may be reduced. For illustrative purposes only, the fabric sheet 50 shown in FIG. 7 could have a predetermined initial width of about 48 inches with a plurality of hydration dams 22 extending longitudinally transverse to the edges 13, 15 of the fabric sheet at about 1 inch intervals. A plurality of perforations 26 define a series of spaced circles designating opening for landscape plantings to extend therethrough.

The following non-limiting examples are given to further illustrate the present invention. In Table 1 below, the absorption capacity of various nonwoven fabrics was measured in accordance with the procedure described above.

TABLE 1
ABSORPTION CAPACITY

| Agrotextile Material | Absorption Capacity |
|---|---|
| 1.0 oz SBPP (BBA Nonwovens) | 3.9 |
| 2.0 oz Typar ® (BBA Nonwovens) | 3.2 |
| 2.8 oz Duon ™ (BP) | 5.0 |
| 3.5 oz Duon ™ (BP) | 6.8 |
| Example #1 | 2.7 |
| Example #2 | 2.5 |
| Example #3 | 4.8 |
| Example #4 | 6.6 |

### Example #1

A landscape fabric in accordance with the present invention was fabricated using two layers of 1.0 oz/yd² spunbonded polypropylene that had been adhesively laminated together using a generic spray-type adhesive. As shown in Table 1, the added adhesive used in the lamination decreased the absorption capacity of the composite agrotextile as compared to the individual layers.

### Example #2

A landscape fabric was fabricated using a top layer of 2.0 oz/yd² Typar® spunbond polyolefin material laminated to a back sheet of 1.0 oz/yd² spunbond polypropylene using a generic spray-type adhesive. Similar to that observed in Example #1, absorption capacity appeared to have been compromised when using the spray adhesive.

### Example #3

A nonwoven fabric formed of 2.8 oz/yd² Duon™ was adhesively laminated to a layer of 1.0 oz/yd² spunbond polypropylene. Advantageously, this composite appeared to exhibit essentially the same absorption capacity as in the non-laminated form.

### Example #4

A 3.5 oz/yd² Duon™ nonwoven fabric was adhesively laminated to a layer of 1.0 oz/yd² spunbond polypropylene. This embodiment performed similarly to Example #3.

Pursuant to the results shown in Table 1, a circular disk approximately 36 inches in diameter was fabricated from the fabric of Example #4. A plurality of circular hydration dams were formed on the top surface of the agrotextile using a hotmelt adhesive device. The hydration dams which were about ⅛ inch wide by about ⅛ inch high, and spaced about 1 inch apart starting in the center of the pervious material and finishing on the outermost edge of the disk.

This disk was placed around the base of a Crepe Myrtle. Within 8 feet of this planting, was an essentially identical Crepe Myrtle. Both plants were established about 12 months earlier. The landscaping fabric was placed around the base of the test plant, and about 6 inches of shredded red tree bark mulch was placed over the fabric as would be the case in a consumer application. The disk had an outside dimension of 36 inches to match up with the plants natural drip line. A similar amount of mulch was used on the other Crepe Myrtle except without the landscaping fabric. The trees were left “as is” and allowed to respond to the elements, meaning no supplemental fertilizer or irrigation water was used during the evaluation.

After about 8 months, the trees were observed and recorded using photo documentation. A significant difference was obvious between the foliage growth on the plant that had the subject patent agrotextile as compared to the plant that did not have the agrotextile.

As a follow-up trial, a multi-layer landscape fabric was prepared having a composition similar to Example #4, but in this trial fertilizer was added between the top and back sheets, and placed around the Crepe Myrtle that did not originally have the benefit of the landscape fabric used in the initial trial. Within 4 months of adding the multi-layer landscape fabric, the growth of both plants was visibly identical.

A similar study was undertaken on a pair of substantially identical Dogwood trees. A landscaping fabric similar to the multi-layer fabric used in the follow-up trial described above was installed around the base of the Dogwood trees. The trees were established about 5 years earlier, and even with added fertilizer the trees did not experience any significant growth. After several months using the landscaping fabrics of the present invention, significant growth was observed in both trees.

These results demonstrate that a landscape fabric in accordance with the present invention offers enhanced moisture control through the use of a plurality of hydration dams. The hydration dams serve to prevent the run-off of irrigated and natural water by holding the water on the surface of the agrotextile giving it time to adsorb and transport the liquid through the pervious base fabric and into the plant root system.

Thus, the landscaping fabric of the present invention provides an advantageous solution to landscaping hydration systems by providing a plurality of water impervious hydration dams on the surface of a fluid pervious sheet material to prevent run-off of irrigated and natural water by holding the water on the surface of the landscaping fabric and thus providing more time for the water to by absorbed by the fabric and transported or “time” released into the underlying soil and root systems.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A landscape fabric, comprising:
at least one layer of a fluid pervious sheet material, said material having a first surface and a second surface; and
at least one hydration dam carried by and projecting from the first surface of said material.

2. A landscape fabric according to claim 1, wherein said at least one hydration dam is formed from a water impermeable thermoplastic material.

3. A landscape fabric according to claim 1, wherein said at least one hydration dam is self-adhered to the first surface of said material.

4. A landscape fabric according to claim 1, wherein said at least one hydration dam is adhered to the first surface of said material with an adhesive.

5. A landscape fabric according to claim 1, wherein said at least one hydration dam comprises a plurality of water impermeable ribs carried by and projecting from the first surface of said material, each rib being arranged to form a predetermined geometrical configuration on the first surface of said material.

6. A landscape fabric according to claim 5, wherein said ribs are arranged to form a plurality of endless closed geometrical shapes.

7. A landscape fabric according to claim 6, wherein said endless closed geometrical shapes form a plurality of concentric circles.

8. A landscape fabric according to claim 5, wherein said ribs are arranged to form a plurality of substantially parallel stripes.

9. A landscape fabric according to claim 5, additionally including a plurality of perforations formed in said material to facilitate separating and removing portions of said material.

10. A landscape fabric according to claim 9, wherein the plurality of perforations define a plurality of concentric circles.

11. A landscape fabric according to claim 1, wherein said material has an absorption capacity ratio of at least about 1.0.

12. A landscape fabric according to claim 9, wherein said material has an absorption capacity ratio of at least about 4.5.

13. A landscape fabric according to claim 1, additionally including a second layer of fluid pervious sheet material positioned in opposing facing relation with the second surface of said at least one layer of sheet material.

14. A landscape fabric, comprising:
an air and water permeable nonwoven sheet material formed of synthetic polymer fibers, said nonwoven sheet material having a first surface and a second surface; and
a plurality of water impermeable hydration dams carried by and projecting from the first surface of said nonwoven sheet material.

15. A landscape fabric according to claim 14, wherein said hydration dams comprise water impermeable ribs carried by and projecting from the first surface of said material, each rib being arranged to form a predetermined geometrical configuration on the first surface of said nonwoven sheet material.

16. A landscape fabric according to claim 15, wherein said ribs are formed from a water impermeable thermoplastic material adhered to said first surface of said nonwoven sheet material.

17. A landscape fabric according to claim 14, including an additional air and water permeable layer adhered to said second surface of said nonwoven sheet material.

18. A landscape fabric according to claim 17, further comprising at least one additive selected from the group consisting of fertilizers, fungicides, insecticides, nutritional supplements, pre-emergent herbicides, and post-emergent herbicides.

19. A landscape fabric according to claim 17, additionally including a plurality of perforations formed in said material to facilitate separating and removing portions of said material.

20. A landscape fabric according to claim 14, wherein said hydration dams are arranged to define a plurality of concentric circles, and including an opening formed in the sheet material at the center of the concentric circles and a slit formed in sheet material and extending radially outwardly from said center.

21. A landscape fabric according to claim 20, additionally including a plurality of concentric perforations formed in the sheet material and adapted for sizing the landscape fabric into a circular shape in one of several preselected diameters.

22. A landscape fabric according to claim 14 which is in the form of a roll of predetermined width, and wherein said hydration dams comprise water impermeable ribs carried by and projecting from the first surface of said material, the ribs extending longitudinally transverse to the width dimension of the roll.

23. A landscape fabric, comprising:
a first fluid pervious layer having a first surface and a second surface;
at least one hydration dam carried by and projecting from the first surface of said first layer;
a second fluid pervious layer positioned proximate the second surface of said first layer; and
an additive layer interposed between said first layer and said second layer.

24. A landscape fabric according to claim 23, wherein said additive layer includes at least one additive selected from the group consisting of fertilizers, fungicides, insecticides, nutritional supplements, pre-emergent herbicides, and post-emergent herbicides.

25. A landscape fabric according to claim 23, wherein said at least one hydration dam includes a plurality of spaced apart hydration dams projecting from the first surface of said first layer.

26. A landscape fabric according to claim 23, wherein said first and second layers are formed from a nonwoven material.

27. A landscape fabric according to claim 23, wherein at least one of said first layer and said second layer is biodegradable.

28. A landscape fabric according to claim 23, including a plurality of perforations extending through said first and second layers for separating and removing portions of the fabric.

29. A landscape fabric, comprising:
first and second layers of an air and water permeable nonwoven sheet material formed of synthetic thermoplastic polymer fibers, each layer of said nonwoven sheet material having an outwardly facing surface and an inwardly facing surface;
a plurality of bonds bonding together said first and second layers to form a composite nonwoven fabric, and
a plurality of water impermeable hydration dams carried by and projecting from the outwardly facing surface of said first layer of nonwoven sheet material.

30. A landscape fabric according to claim 29, wherein said first layer of nonwoven fabric has a basis weight of about 0.5 to 5 ounces per square yard and said second layer of nonwoven fabric has a basis weight of about 0.5 to 5 ounces per square yard.

31. A landscape fabric according to claim 29, including a thermoplastic adhesive located between said first and second layers and forming said plurality of bonds.

32. A landscape fabric according to claim 29, including at least one additive provided in the fabric between said first and second layers, said additive being selected from the group consisting of fertilizers, fungicides, insecticides, nutritional supplements, pre-emergent herbicides, and post-emergent herbicides.
